(19) United States
(12) Patent Application Publication
(10) Pub. No.: US 2025/0217702 A1
(43) Pub. Date: Jul. 3, 2025

(54) METHOD AND THE DEVICE FOR OPERATING A TECHNICAL SYSTEM

(71) Applicant: Robert Bosch GmbH, Stuttgart (DE)

(72) Inventors: Barbara Rakitsch, Stuttgart (DE); Christoph Lippert, Berlin (DE); Jakob Lindinger, Freiburg (DE)

(21) Appl. No.: 18/850,707

(22) PCT Filed: May 9, 2023
(86) PCT No.: PCT/EP2023/062296

§ 371 Date: Sep. 25, 2024

(30) Foreign Application Priority Data
May 13, 2022 (EP) 22 17 3335.5

(51) Int. Cl. G06N 20/00; G06F 17/17

(52) U.S. Cl. CPC G06N 20/00; G06F 17/17

(57) ABSTRACT

A device and computer-implemented method for machine learning with time-series data representing observations related to a technical system. The comprising includes: providing (the time-series data, and model parameters of a distribution over the time-series data and over a first latent variable and over a second latent variable, and variational parameters of an approximate distribution over a second latent variable, sampling a value of the second latent variable from the approximate distribution over the second latent variable, finding a value of the first latent variable depending on a density of the distribution over the time-series data and over the first latent variable and over the value of the second latent variable, determining a Hessian depending on a second order Taylor approximation of the distribution over the time-series data and the first latent variable and the value of the second latent variable evaluated at the value of the first latent variable.

### FIELD

The present invention relates to a method and device for operating a technical system.

### BACKGROUND INFORMATION

Gaussian process state-space models use Gaussian processes as the transition function in a state-space model to describe time series data in a fully probabilistic manner. These models have two types of latent variables, the temporal states required for modelling noisy sequential observations, and the so-called inducing outputs which are needed to treat the Gaussian process part of the model in an efficient manner.

Ialongo, Alessandro Davide, Mark Van Der Wilk, James Hensman, and Carl Edward Rasmussen. “Overcoming Mean-Field Approximations in Recurrent Gaussian Process Models.” International Conference on Machine Learning. 2019 describe a use of Variational Inference to approximate a true posterior of a Gaussian process model. A conditional dependence of temporal states on the inducing outputs is taken into account and a Markov Gaussian model over the temporal states is assumed. The Markov Gaussian model is parametric and allows for non-linear transitions.

Skaug, Hans Julius and David A. Fournier. “Automatic approximation of the marginal likelihood in non-Gaussian hierarchical models.” Comput. Stat. Data Anal. 51, pp. 699-709. 2006 describe an application of the Laplace approximation to generic, i.e. not Gaussian process, state-space models in an efficient manner. This is possible by using the Implicit Function Theorem and exploiting the sparsity and structure of the Hessian, i.e. a matrix that is needed for applying the Laplace approximation.

### SUMMARY

A computer-implemented method and the device according to the present invention provides a model and a combination of these inference methods by treating two different types of the latent variables in Gaussian process state-space model distinctly and applying variational inference to a Gaussian process part of the model and the Laplace approximation to the temporal states of the model. The distinction of the two types of latent variables makes it possible to process the model efficiently. The method does not require sequential sampling of the temporal states during inference and instead performs the Laplace approximation that involves a joint optimization over those temporal states. This point helps in optimizing the model. The approximate posterior that is used in the model further assumes that dynamics can be locally linearly approximated. The improvements in the optimization that are provided by this model also lead to better calibrated uncertainties for different time-series prediction tasks.

According to an example embodiment of the present invention, the computer-implemented method for machine learning with time-series data representing observations related to a technical system, comprises providing the time-series data, and model parameters of a distribution over the time-series data and over a first latent variable and over a second latent variable, and variational parameters of an approximate distribution over a second latent variable, sampling a value of the second latent variable from the approximate distribution over the second latent variable, finding a value of the first latent variable depending on a density of the distribution over the time-series data and over the first latent variable and over the value of the second latent variable, in particular that maximizes the density of the distribution over the time-series data and over the first latent variable and over the value of the second latent variable, determining a Hessian depending on a second order Taylor approximation of the distribution over the time-series data and the first latent variable and the value of the second latent variable evaluated at the value of the first latent variable, determining a determinant of the Hessian, determining a Laplace approximation of a distribution over the time-series data conditioned with the value of the second latent variable depending on the determinant of the Hessian, determining an inverse of the Hessian, determining a Jacobian of the distribution over the time-series data and the first latent variable and the value of the second latent variable, evaluating an approximate lower bound that depends on the Laplace approximations that are determined for a plurality of values of the second latent variable, determining gradients of the Laplace approximations depending on the inverse Hessians and the Jacobians, updating the model parameters and the variational parameters depending on the gradients. This method uses a distinction of two types of latent variables, and uses an approximate posterior, and assumes that the dynamics can be locally linearly approximated. This method provides an improved way of doing inference in Gaussian process state-space models. The method has the following advantages: The method does not require sequential sampling of the temporal states during inference and instead performs the Laplace approximation that involves a joint optimization over those temporal states.

According to an example embodiment of the present invention, preferably, providing the time-series data comprises receiving the time-series data or receiving a sensor signal comprising information about the technical system and determining the time-series data depending on the sensor signal.

According to an example embodiment of the present invention, the method preferably comprises determining an instruction for actuating the technical system depending on the time-series data, the model parameters and the variational parameters, and outputting the instruction to cause the technical system to act.

Preferably, the technical system is a computer-controlled machine, like a robot, in particular a vehicle, a domestic appliance, a power tool, a manufacturing machine, a personal assistant or an access control system.

The technical system may comprise an engine or a part thereof, wherein the time-series data comprises as input to the technical system a speed and/or a load, and as output of the technical system an emission, a temperature of the engine, or an oxygen content in the engine.

The technical system may comprise a fuel cell stack or a part thereof, wherein the time-series data comprises as input to the technical system a current in the fuel cell stack, a hydrogen concentration in the fuel cell stack, a stoichiometry of an anode or a cathode of the fuel cell stack, a volume stream of a coolant for the fuel cell stack, an anode pressure for an anode of the fuel cell stack, a cathode pressure for a cathode of the fuel cell stack, an inlet temperature of a coolant for the fuel cell stack, an outlet temperature of a coolant for the fuel cell stack, an anode dew point temperature of an anode of the fuel cell stack, a cathode dew point temperature of a cathode of the fuel cell stack, and as output of the technical system (102) an average of the cell tensions across cells of the fuel cell stack, an anode pressure drop at an anode of the fuel cell stack, a cathode pressure drop at a cathode of the fuel cell stack, a coolant pressure drop between an inlet and an outlet for the coolant of the fuel cell stack, or a coolant temperature rise between an inlet and an outlet for the coolant of the fuel cell stack.

The instruction preferably comprises a target operating mode for the technical system.

According to an example embodiment of the present invention, the method may comprise determining the determinant of the Hessian depending on a factorization comprising a strictly upper triangular part of a part of the Hessian a strictly lower triangular part of the part of the Hessian and a block diagonal matrix of recursively defined blocks of a matrix. This is a very computing resource efficient way of determining the Hessian.

The method may comprise determining the inverse of the Hessian depending on a factorization comprising a strictly upper triangular part of a part of the Hessian a strictly lower triangular part of the part of the Hessian and a block diagonal matrix of recursively defined blocks of a matrix. This is a very computing resource efficient way of determining the inverse of the Hessian.

Evaluating the approximate lower bound may comprise sampling with samples of the second latent variable that are drawn from the approximate distribution over the second latent variable.

According to an example embodiment of the present invention, the device for machine learning with time-series data representing observations related to a technical system comprises at least one processor and at least one memory, wherein the at least one processor is adapted to execute instructions that when executed by the at least one processor cause the device to perform steps in a method for operating the technical system according to the present invention. This device provides advantages that correspond to the advantages the method of the present invention provides.

The device may comprises an interface that is adapted to receive information about the technical system and/or that is adapted to output an instruction that causes the technical system to act. This device is capable of interacting with the technical system.

A computer program may comprise computer readable instructions that when executed by a computer cause the computer to perform the steps of the method of the present invention.

Further advantageous embodiments are derived from the following description and the figures.

### BRIEF DESCRIPTION OF THE DRAWINGS

FIG. 1 schematically depicts a device for operating a technical system, according to an example embodiment of the present invention.

FIG. 2 schematically depicts steps in a method for operating the technical system, according to an example embodiment of the present invention.

### DETAILED DESCRIPTION OF EXAMPLE EMBODIMENTS

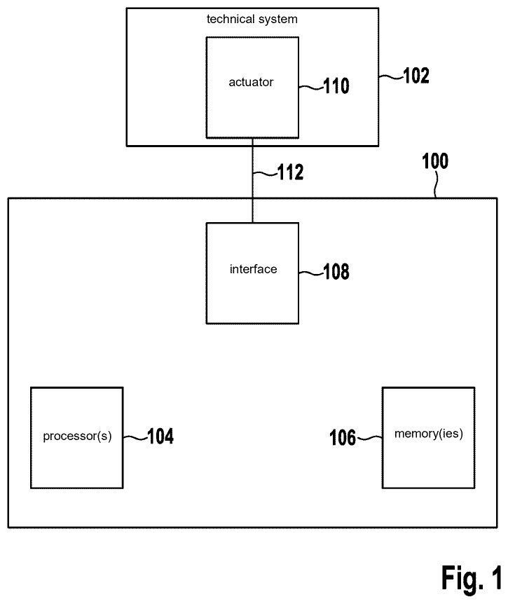

FIG. 1 depicts a device 100 for operating a technical system 102 schematically.

The device 100 comprises at least one processor 104 and at least one memory 106. The at least one processor 104 is adapted to execute instructions that when executed by the at least one processor 104 cause the device 100 to perform steps in a method for operating the technical system 102.

The device 100 in the example comprises an interface 108. The interface 108 is for example adapted to receive information about the technical system 102. The interface 108 is for example adapted to output an instruction that causes the technical system 102 to act. The technical system 102 may comprise an actuator 110. The actuator 110 may be connected at least temporarily with the interface 108 via a signal line 112.

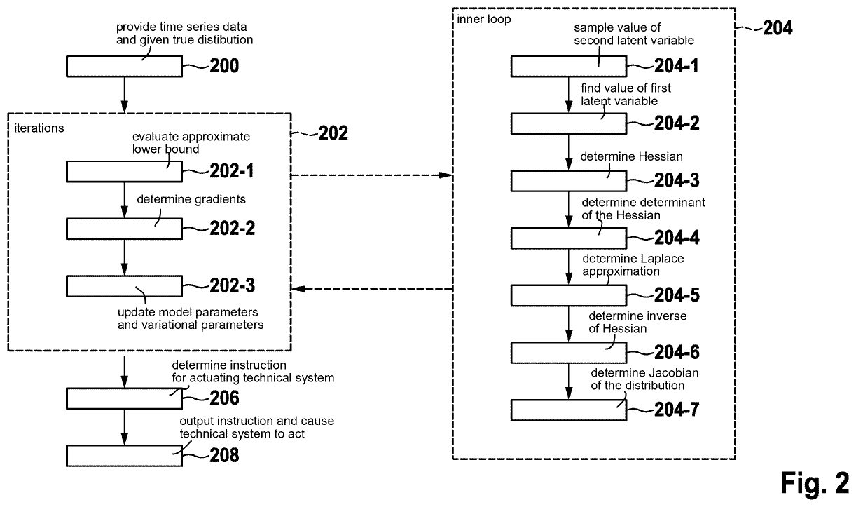

FIG. 2 depicts steps of the method. The method comprises analyzing data, e.g. given time-series data Y_{T}={yₜ}ₜ₌₁^{T} with yₜ∈ [symbol] ^{d}^{_{y}} of a given dimension d_{y}, and then operating the technical system 102 accordingly.

The time series data Y_{T} comprises for example noisy observations from the technical system 102.

In addition to the time series data Y_{T} the method may consider additional dᵤ dimensional time series data U_{T} with uₜ∈R^{d}^{ᵤ}.

The technical system 102 may comprise an engine or a part thereof. The time-series data may comprise as input to the technical system 102 a speed and/or a load, and as of the technical system 102 output an emission, a temperature of the engine, or an oxygen content in the engine.

The technical system 102 may comprises a fuel cell stack or a part thereof. The time-series data may comprise as input to the technical system 102 a current in the fuel cell stack, a hydrogen concentration in the fuel cell stack, a stoichiometry of an anode or a cathode of the fuel cell stack, a volume stream of a coolant for the fuel cell stack, an anode pressure for an anode of the fuel cell stack, a cathode pressure for a cathode of the fuel cell stack, an inlet temperature of a coolant for the fuel cell stack, an outlet temperature of a coolant for the fuel cell stack, an anode dew point temperature of an anode of the fuel cell stack, a cathode dew point temperature of a cathode of the fuel cell stack, and as output of the technical system 102 an average of the cell tensions across cells of the fuel cell stack, an anode pressure drop at an anode of the fuel cell stack, a cathode pressure drop at a cathode of the fuel cell stack, a coolant pressure drop between an inlet and an outlet for the coolant of the fuel cell stack, or a coolant temperature rise between an inlet and an outlet for the coolant of the fuel cell stack

The method operates on the given time-series data Y_{T} for a given number I of iterations i and a given number N of samples n.

The method is based on a probabilistic model and an approximate model. The approximate model is based on the fully independent training conditional, FITC, assumption. Details of this assumption are described e.g. in Edward Snelson and Zoubin Ghahramani. Sparse Gaussian Processes using Pseudo-inputs. In Advances in Neural Information Processing Systems, 2005.

The probabilistic model is based on a Gaussian process state-space model wherein a Gaussian process prior is placed on the mean of the transition model that learns the mapping from a latent state xₜ₋₁ to the next latent state xₜ:

$${p}_{Θ} ( {Y}_{T} , {X}_{{T}_{0}} , {F}_{T} ) = {p}_{Θ} ( {x}_{0} ) {p}_{Θ} ( {F}_{T} \vert {X}_{{T}_{0}} ) {\prod }_{t = 1}^{T} {p}_{Θ} ( {y}_{t} \vert {x}_{t} ) {p}_{Θ} ( {x}_{t} \vert {x}_{t - 1} , {f}_{t - 1} )$$

wherein the initial distribution p_{Θ}(x₀) and the emission model p_{Θ}(yₜ|xₜ) are left unspecified, and the transition model is given by

$${p}_{Θ} ( {x}_{t} \vert {x}_{t - 1} , {f}_{t - 1} ) = N ( {x}_{t} \vert {x}_{t - 1} + {f}_{t - 1} , Q )$$

where N is iid. Gaussian noise with variance Q, where F_{T}={ƒ(xₜ)}ₜ₌₀^{T-1}, and wherein in the example, ƒ˜GP(0,k (⋅,⋅)) is zero-mean Gaussian process, i.e. a distribution over functions that is fully specified by a positive-definite, symmetric kernel k(⋅,⋅)∈ [symbol] ^{d}^{ₓ}^{×d}^{ₓ}→ [symbol] .

In case the method considers the additional dᵤ dimensional time series data U_{T} with uₜ∈ [symbol] ^{d}^{ᵤ} the kernel of the Gaussian process accepts input pairs of dimension [symbol] ^{d}^{ₓ}^{+d}^{ᵤ}.

The probabilistic model comprises a first latent variable. The first latent variable is in the example a temporal state X_{T}_{₀}={xₜ}ₜ₌₀^{T} with xₜ∈ [symbol] ^{d}^{ₓ} of a given dimension dₓ.

Gaussian Process posteriors can be summarized by sparse Gaussian processes in which the information of the posterior is contained in the pseudo-dataset (X_{M}, F_{M}) where X_{M} are the inducing inputs and F_{M} are the inducing outputs.

The inducing output F_{M} and F_{T} share a joint Gaussian distribution p_{Θ}(F_{T}, F_{M}). The model employs the fully independent training conditional approximation that assumes independence of the latent GP evaluations given the inducing outputs:

$${p}_{Θ} ( {F}_{T} \vert {X}_{{T}_{0}} , {F}_{M} ) \approx {\prod }_{t = 1}^{T - 1} {p}_{Θ} ( {f}_{t} \vert {x}_{t} , {F}_{M} )$$

that leads to:

$${p}_{Θ} ( {Y}_{T} , {X}_{{T}_{0}} , {F}_{M} ) = p ( {F}_{M} ) {p}_{Θ} ( {Y}_{T} , {X}_{{T}_{0}} \vert {F}_{M} )$$

$$with$$

$${p}_{Θ} ( {Y}_{T} , {X}_{{T}_{0}} \vert {F}_{M} ) = {p}_{θ} ( {x}_{0} ) {\prod }_{t = 1}^{T} {p}_{θ} ( {y}_{t} \vert {x}_{t} ) {p}_{θ} ( {x}_{t} \vert {x}_{t - 1} , {F}_{M} )$$

The inducing output F_{M} is a second latent variable.

In case the method considers additional dᵤ dimensional time series data U_{T} with uₜ∈R^{d}^{ᵤ} the inducing points X_{M} live in that higher dimensional space [symbol] ^{d}^{ₓ}^{+d}^{ᵤ}.

The approximate model comprises a distribution over the time-series data Y_{T} and the first latent variable, e.g. the temporal state X_{T}_{₀}, and the second latent variable, e.g. the inducing output F_{M}.

Lower bounding the log marginal log-likelihood log p_{Θ}(Y_{T}) by variational inference allows finding an approximation to the true posterior over the inducing outputs p_{Θ}(F_{M}|Y_{T}):

$$log {p}_{θ} ( {Y}_{T} ) \geq \int {q}_{Ψ} ( {F}_{M} ) log {p}_{θ} ( {y}_{T} \vert {F}_{M} ) {dF}_{M} - KL ( {q}_{Ψ} ( {F}_{M} ) \vert \vert {p}_{θ} ( {F}_{M} ) ) ,$$

$$where {p}_{θ} ( {Y}_{T} \vert {F}_{M} ) = \int {p}_{θ} ( {Y}_{T} , {X}_{{T}_{0}} \vert {F}_{M} ) {dX}_{{T}_{o}} .$$

The approximate model comprises an approximate distribution over the second latent variable, e.g. a variational distribution q_{Ψ}(F_{M})=N(F_{M}|m, S) over the inducing output F_{M} with mean m and variance S. These are e.g. given initial variational parameters Ψ={m, S}.

For every inducing input X_{M}={xₘ}ₘ₌₀^{M} with xₘ∈ [symbol] ^{d}^{ₓ} the inducing output F_{M} is distributed according to a given approximate distribution q_{Ψ}(F_{M}) over the inducing output F_{M}.

The inducing input X_{M} and the inducing output F_{M} are referred to as pseudo data point. The prior over the inducing outputs is given by the Gaussian process prior p(F_{M})=N(F_{M}|0, K_{MM}), where K_{MM}={k(xₘ, x_{m′}}_{m,m′=1}^{M}.

The approximate model comprises a predictive distribution p(xₜ|xₜ₋₁, F_{M})=N (xₜ|xₜ₋₁+μ(xₜ₋₁, F_{M}),Σ(xₜ₋₁)+Q), where the mean is given by μ(xₜ, F_{M})=K_{tM}K_{MM}⁻¹F_{M} and the covariance is given by Σ(xₜ)=kₜₜ−K_{tM}K_{MM}⁻¹K_{tM}^{T}, wherein kₜₜ=k(xₜ, xₜ) and K_{tM}={k(xₜ, xₘ)}ₘ₌₁^{M}.

The method comprises a step 200.

The step 200 comprises providing the time series data Y_{T}. The time series data U_{T} may be provided and used additionally.

The method may comprise receiving the time series data Y_{T} at the interface 108.

Step 200 may comprise receiving a sensor signal comprising information about the technical system 102 and determining the time-series data Y_{T} depending on the sensor signal. The time series data U_{T} may be received or determined from a received sensor signal additionally. The time series data uₜ is for example concatenated with the latent state xₜ and used as input to the transition model and kernel function.

The step 200 comprises providing a given true distribution p_{Θ}(Y_{T}, X_{T}_{₀}|F_{M}) over time-series data Y_{T} and the latent states X_{T}_{₀} that is conditioned on an inducing output F_{M}. This means, providing a distribution over the time-series data Y_{T} and the first latent variable X_{T}_{₀} and the second latend variable F_{M}.

The method operates with given initial model parameters Θ and the given initial variational parameters Ψ′={m, S}.

The method comprises an outer loop 202 and an inner loop 204.

The outer loop 202 is processed for iterations i=1, . . . , I. In the iterations, the model and variational parameters are optimized.

The inner loop 204 is processed for samples n=1, . . . , N. The samples are used to obtain a stochastic approximation to the log-likelihood.

The inner loop 204 comprises a step 204-1.

The step 204-1 comprises sampling a value of the second latent variable from the approximate distribution over the second latent variable.

In the example, an inducing output sample F_{M}⁽ⁿ⁾ is determined from the distribution q_{Ψ}(F_{M}) over the inducing output F_{M}:

$${F}_{M}^{( n )} ∼ {q}_{Ψ} ( {F}_{M} )$$

The inner loop 204 comprises a step 204-2.

The step 204-2 comprises finding a value of the first latent variable depending on the density of the distribution over the time-series data and the first latent variable and the value of the second latent variable. In the example, step 204-2 comprises finding a value of the first latent variable for that the density of the distribution over the time-series data and the first latent variable and the value of the second latent variable is maximized.

In the example, a mode

$${\hat{X}}_{{T}_{o}}^{( n )}$$

is found that is a maximizer of a logarithmic density

$${g}_{G P} ( {X}_{{T}_{0}} , Θ , {F}_{M} ) = log {p}_{Θ} ( {Y}_{T} , {X}_{{T}_{0}} \vert {F}_{M}^{( n )} )$$

with respect to the latent states X_{T}_{₀},

$${\hat{X}}_{{T}_{0}}^{( n )} = arg {max}_{{X}_{{T}_{0}}} {g}_{GP} ( {X}_{{T}_{0}} , Θ , {F}_{M}^{( n )} )$$

This means, the method comprises finding a mode

$${\hat{X}}_{{T}_{0}}^{( n )}$$

that maximizes the logarithmic density.

The inner loop 204 comprises a step 204-3.

The step 204-3 comprises determining a Hessian of the logarithmic density g_{GP}(X_{T}_{₀}, Θ, F_{M}⁽ⁿ⁾) depending on a mode of first latent variable \hat{X}_{T}_{₀} the model parameters Θ, and the value of the second latent variable F_{M}⁽ⁿ⁾.

In the example, non-zero elements of a Hessian H(Aₜ, Bₜ)∈ [symbol] ^{d}^{ₓ}^{(T+1)×d}^{ₓ}^{(T+1)} are obtained, wherein

$${{A}_{t} = - \frac{{\partial }^{2} {g}_{G P} ( {X}_{{T}_{0}} , Θ , {F}_{M}^{( n )} )}{\partial {x}_{t} \partial {x}_{t}} \vert}_{{X}_{{T}_{0} = {\hat{X}}_{{T}_{o}}}} ∈ {ℝ}^{{d}_{x} \times {d}_{x}}$$

$${{B}_{t} = - \frac{{\partial }^{2} {g}_{G P} ( {X}_{{T}_{0}} , Θ , {F}_{M}^{( n )} )}{\partial {x}_{t} \partial {x}_{t - 1}} \vert}_{{X}_{{T}_{0} = {\hat{X}}_{{T}_{o}}}} ∈ {ℝ}^{{d}_{x} \times {d}_{x}}$$

In the example the non-zero elements comprise the quantities {Aₜ}ₜ₌₁^{T} and {Bₜ}ₜ₌₁^{T}. The Hessian is used to provide a second order Taylor approximation of g_{GP}(X_{T}_{₀}, Θ, F_{M}⁽ⁿ⁾) around the mode \hat{X}_{T}_{₀}. Note that Y_{T} is constant.

In the example, the non-zero elements of the Hessian are determined with only 3dₓ vector-Hessian products, reducing the memory and time requirements to O(Tdₓ²).

The inner loop 204 comprises a step 204-4.

The step 204-4 comprises determining a determinant of the Hessian.

The determinant of the Hessian is determined for example depending on a factorization comprising a strictly upper triangular part of a part of the Hessian a strictly lower triangular part of the part of the Hessian and a block diagonal matrix of recursively defined blocks of a matrix.

In the example, a determinant det H(Aₜ, Bₜ) of the Hessian H(Aₜ, Bₜ) is evaluated.

In the example, the determinant det H(Aₜ, Bₜ) of the Hessian H(Aₜ, Bₜ) is determined from a factorization

$$H ( {A}_{t} , {B}_{t} ) = ( Λ + {B}^{T} ) {Λ}^{- 1} ( Λ + B )$$

wherein B is the strictly upper triangular part of the Hessian H(Aₜ, Bₜ) comprising of the different Bₜ and Λ is a block diagonal matrix of recursively defined blocks:

$${Λ}_{0} = {A}_{0} , {Λ}_{t} = {A}_{t} - {B}_{t}^{T} {Λ}_{t - 1}^{T} {B}_{t} , t = 1 , … , T$$

$$as$$

$$det H ( {A}_{t} , {B}_{t} ) = {\prod }_{t = 0}^{T} det {Λ}_{t}$$

wherein Λₜ is a block diagonal matrix and Bₜ is strictly upper triangular and Bₜ^{T} is strictly lower triangular. These operations can be performed in O(Tdₓ³) steps.

The inner loop 204 comprises a step 204-5.

The step 204-5 comprises determining a Laplace approximation of a distribution over the time-series data conditioned with the value of the second latent variable depending on the determinant of the Hessian.

In the example, a Laplace approximation \tilde{p}_{Θ}(Y_{T}|F_{M}⁽ⁿ⁾) of a conditional p_{Θ}(Y_{T}|F_{M}⁽ⁿ⁾) is evaluated:

$${\tilde{p}}_{Θ} ( {Y}_{T} \vert {F}_{M}^{( n )} ) ∝ {p}_{Θ} ( {Y}_{T} , {\hat{X}}_{{T}_{o}}^{( n )} \vert {F}_{M}^{( n )} ) {det ( H ( {A}_{t} , {B}_{t} ) )}^{- 1 / 2}$$

The inner loop 204 comprises a step 204-6.

The step 204-6 comprises determining an inverse of the Hessian. The inverse of the Hessian is determined for example depending on the factorization comprising the strictly upper triangular part of the part of the Hessian the strictly lower triangular part of the part of the Hessian and the block diagonal matrix of recursively defined blocks of the matrix.

In the example, the inverse H⁻¹ of the Hessian H is determined.

The inverse of the Hessian is determined from the factorization.

$${H}^{- 1} = {( Λ + B )}^{- 1} {Λ ( Λ + {B}^{T} )}^{- 1}$$

The inner loop 204 comprises a step 204-7.

The step 204-7 comprises determining a Jacobian of the distribution over the time-series data and the first latent variable and the value of the second latent variable.

In the example, a Jacobian h of the function g_{GP}(X_{T}_{₀}, Θ, F_{M}⁽ⁿ⁾) is determined:

$${h ( {\hat{X}}_{{T}_{0}}^{( n )} , Θ , {F}_{M}^{( n )} ) = - \frac{\partial log {p}_{Θ} ( {Y}_{T} , {X}_{{T}_{0}} \vert {F}_{M}^{( n )} )}{\partial {X}_{{T}_{0}}} \vert}_{{\hat{X}}_{{T}_{0}}^{( n )} = x}$$

The outer loop 202 comprises a step 202-1.

The step 202-1 comprises evaluating an approximate lower bound that depends on the Laplace approximations that are determined for a plurality of values of the second latent variable.

In the example, an approximate lower bound L(Θ, Ψ)

$$L ( Θ , Ψ ) = \int {q}_{Ψ} ( {F}_{M} ) log {\tilde{p}}_{Θ} ( {Y}_{T} \vert {F}_{M} ) d {F}_{M} - K L ( {q}_{Ψ} ( {F}_{M} ) ‖ {p}_{Θ} ( {F}_{M} ) )$$

is evaluated, that comprises a Kullback-Leibler term, KL-term, for comparing the approximate distribution q_{Ψ}(F_{M}) with the true posterior distribution p_{Θ}(F_{M}). The distribution \tilde{p}_{Θ}(Y_{T}|F_{M}) is given by the Laplace approximation around \hat{X}_{T}_{₀}.

In the example, the plurality of values of the second latent variable are the samples of the second latent variable that are determined in step 204-1 when processing the inner loop repeatedly. This means, the approximate lower bound is evaluated depending on samples of the second latent variable that are drawn from the approximate distribution over the second latent variable.

In the example, in order to evaluate and optimize this optimization objective, a parametric family is chosen for the approximate distribution q_{Ψ}(F_{M}).

In the example, q_{Ψ}(F_{M}) is a Gaussian distribution. This allows an analytical evaluation of the KL-term. The other term of L(Θ, Ψ) is analytically intractable. In the example the other term is optimized by sampling:

$$\int {q}_{Ψ} ( {F}_{M} ) log {\tilde{p}}_{Θ} ( {Y}_{T} \vert {F}_{M} ) d {F}_{M} \approx {\sum }_{n = 1}^{N} log {\tilde{p}}_{Θ} ( {Y}_{T} \vert {F}_{M}^{( n )} )$$

with samples of inducing outputs F_{M}^{(N)} that are drawn from the approximate distribution q_{Ψ}(F_{M}) over the inducing output F_{M}.

$${F}_{M}^{( n )} ∼ {q}_{Ψ} ( {F}_{M} )$$

The outer loop 202 comprises a step 202-2.

The step 202-2 comprises determining gradients of the Laplace approximations depending on the inverse Hessians and the Jacobians.

In the example, gradients

$$\frac{\partial L ( Θ , Ψ )}{\partial Θ} and \frac{\partial L ( Θ , Ψ )}{\partial Ψ}$$

of L(Θ, Ψ) are obtained using

$$\frac{\partial {\hat{X}}_{{T}_{0}}^{( n )}}{\partial Θ} = {H}^{- 1} ( Θ , {F}_{M}^{( n )} ) \frac{\partial h ( {\hat{X}}_{{T}_{0}}^{( n )} , Θ , {F}_{M}^{( n )} )}{\partial Θ}$$

$$and$$

$$\frac{\partial {\hat{X}}_{{T}_{0}}^{( n )}}{\partial Ψ} = {H}^{- 1} ( Θ , {F}_{M}^{( n )} ) \frac{\partial h ( {\hat{X}}_{{T}_{0}}^{( n )} , Θ , {F}_{M}^{( n )} )}{\partial Ψ}$$

wherein Ψ are the variational parameters that enter the equation implicitly over the sampled inducing outputs F_{M}⁽ⁿ⁾.

This exchanges a potentially costly automatic differentiation computations with a Hessian solve. This requires only the value \hat{X}_{T}_{₀}⁽ⁿ⁾ so that the complete computational graph of how it has been obtained is no longer required.

The outer loop 202 comprises a step 202-3.

The step 202-3 comprises updating the model parameters and variational parameters depending on the gradients.

In the example, the model parameters Θ and variational parameters Ψ={m, S} are updated.

Updating the model parameters Θ and the variational parameters Ψ={m, S} comprises determining the model parameters Θ and variational parameters Ψ′={m, S} for that minimize L(Θ, Ψ). This means, the model parameters Θ and variational parameters Ψ′={m, S} are determined for that L(Θ, Ψ) is smaller than for other model parameters Θ and variational parameters Ψ′={m, S}.

The aforementioned steps of the method describe an inference method to learn the model parameters Θ and variational parameters Ψ′ of a Gausssian process state space model in a training. These steps may be determined in an offline phase, e.g. for given time-series data Y_{T} and optionally given additional time series data U_{T}.

The following steps of the method may be executed for a prediction e.g. in an online phase. These steps may be executed with a trained model, i.e. with given model parameters Θ and variational parameters Ψ. These steps may be executed independently of the training, i.e. without training, or jointly with the training after the training.

In the example, the model parameters Θ and variational parameters Ψ′ that are determined in a last iteration of updating the model parameters Θ and variational parameters Ψ are used for the prediction.

The method may comprise a step 206.

In the step 206, the method comprises determining an instruction for actuating the technical system 102 depending on the time-series data Y_{T}, the model parameters Θ and the variational parameters Ψ′={m, S}.

Optionally the additional time series data U_{T} may be used as well.

For example, the time-series data comprises as input to the approximate model of the technical system 102 a speed and/or a load. For example, the output of the approximate model of the technical system 102 is an emission, a temperature of the engine, or an oxygen content in the engine.

For example, the time-series data comprises as input to the approximate model of the technical system 102 a current in the fuel cell stack, a hydrogen concentration in the fuel cell stack, a stoichiometry of an anode or a cathode of the fuel cell stack, a volume stream of a coolant for the fuel cell stack, an anode pressure for an anode of the fuel cell stack, a cathode pressure for a cathode of the fuel cell stack, an inlet temperature of a coolant for the fuel cell stack, an outlet temperature of a coolant for the fuel cell stack, an anode dew point temperature of an anode of the fuel cell stack, a cathode dew point temperature of a cathode of the fuel cell stack. For example, the output of the approximate model of the technical system 102 is an average of the cell tensions across cells of the fuel cell stack, an anode pressure drop at an anode of the fuel cell stack, a cathode pressure drop at a cathode of the fuel cell stack, a coolant pressure drop between an inlet and an outlet for the coolant of the fuel cell stack, or a coolant temperature rise between an inlet and an outlet for the coolant of the fuel cell stack.

The instruction for example comprises a target operating mode for the technical system 102. The target operating mode may be determined depending on the output of the approximate model, e.g. by a controller or a characteristic curve or a map that maps the output to the target operating mode.

The method may comprise a step 208.

In the step 208, the method comprises outputting the instruction to cause the technical system 102 to act.

The instruction for example comprises the target operating mode for the technical system 102.

The time series data Y_{T} may be processed in the training in minibatches. A minibatch is a subsequence

$${Y}_{b} = {\{ {y}_{t} \}}_{t = {t}_{0}}^{{t}_{0} + {T}_{b}}$$

of the time series data Y_{T} of length T_{b} and starting at an arbitrary time index t₀. The method may be applied to minibatches. The method may comprise drawing a minibatch for a sample from the approximate distribution q_{Ψ}(F_{M}) and approximate the term

$$\int {q}_{Ψ} ( {F}_{M} ) log {\tilde{p}}_{Θ} ( {Y}_{T} \vert {F}_{M} ) d {F}_{M} \approx \frac{T}{{T}_{b}} {\sum }_{n = 1}^{N} log {\tilde{p}}_{Θ} ( {Y}_{{T}_{b}}^{( n )} \vert {F}_{M}^{( n )} ) , {F}_{M}^{( n )} ∼ {q}_{Ψ} ( {F}_{M} )$$

The method is applied to one-dimensional or multidimensional latent states xₜ alike. For multi-dimensional latent states xₜ an independent Gaussian process may be used for each dimension of the latent state xₜ:

$${p}_{Θ} ( {χ}_{t} \vert {x}_{t - 1} , {F}_{M}^{{d}_{x}} ) = {\prod }_{d = 1}^{{d}_{x}} N ( {x}_{t}^{( d )} \vert {x}_{t - 1}^{( d )} + {μ}^{( d )} ( {x}_{t - 1} , {F}_{M}^{( d )} ) , {q}_{d} + {Σ}^{( d )} ( {x}_{t - 1} ) )$$

$$where {F}_{M}^{{d}_{x}} = {\{ {F}_{M}^{( d )} \}}_{d = 1}^{{d}_{x}}$$

is a collection of all inducing outputs, xₜ^{(d)} is the d-th dimension of the latent state and μ^{(d)} is the mean and Σ^{(d)} is the covariance of the Gaussian process of the d-th dimension.

1-13. (canceled)

14. A computer-implemented method for machine learning with time-series data representing observations related to a technical system, the method comprising the following steps:
providing the time-series data, and model parameters of a distribution over the time-series data and over a first latent variable and over a second latent variable, and variational parameters of an approximate distribution over the second latent variable;
sampling a value of the second latent variable from the approximate distribution over the second latent variable;
finding a value of the first latent variable depending on a density of the distribution over the time-series data and over the first latent variable and over the value of the second latent variable, that maximizes the density of the distribution over the time-series data and over the first latent variable and over the value of the second latent variable;
determining a Hessian depending on a second order Taylor approximation of the distribution over the time-series data and the first latent variable and the value of the second latent variable evaluated at the value of the first latent variable;
determining a determinant of the Hessian;
determining a Laplace approximation of a distribution over the time-series data conditioned with the value of the second latent variable depending on the determinant of the Hessian;
determining an inverse of the Hessian;
determining a Jacobian of the distribution over the time-series data and the first latent variable and the value of the second latent variable;
evaluating an approximate lower bound that depends on the Laplace approximations that are determined for a plurality of values of the second latent variable; and
determining gradients of the Laplace approximations depending on the inverse Hessian and the Jacobian; and
updating the model parameters and the variational parameters depending on the gradients.

15. The method according to claim 14, wherein the providing of the time-series data includes: (i) receiving the time-series data, or (ii) receiving a sensor signal including information about the technical system and determining the time-series data depending on the sensor signal.

16. The method according to claim 14, further comprising:
determining an instruction for actuating the technical system depending on the time-series data, the model parameters, and the variational parameters; and
outputting the instruction to cause the technical system to act.

17. The method according to claim 14, wherein the technical system is a computer-controlled machine, or a robot, or a vehicle, or a domestic appliance, or a power tool, or a manufacturing machine, or a personal assistant, or an access control system.

18. The method according to claim 14, wherein the technical system includes an engine or a part of an engine, wherein the time-series data includes as input to the technical system a speed and/or a load, and as output of the technical system an emission, or a temperature of the engine, or an oxygen content in the engine.

19. The method according to claim 14, wherein the technical system includes a fuel cell stack or a part of a fuel cell stack, wherein the time-series data includes as input to the technical system: (i) a current in the fuel cell stack, or (ii) a hydrogen concentration in the fuel cell stack, or (iii) a stoichiometry of an anode or a cathode of the fuel cell stack, or (iv) a volume stream of a coolant for the fuel cell stack, or (v) an anode pressure for an anode of the fuel cell stack, or (vi) a cathode pressure for a cathode of the fuel cell stack, or (vii) an inlet temperature of a coolant for the fuel cell stack, or (viii) an outlet temperature of a coolant for the fuel cell stack, or (ix) an anode dew point temperature of an anode of the fuel cell stack, or (x) a cathode dew point temperature of a cathode of the fuel cell stack, and as output of the technical system: (i) an average of the cell tensions across cells of the fuel cell stack, or (ii) an anode pressure drop at an anode of the fuel cell stack, or (iii) a cathode pressure drop at a cathode of the fuel cell stack, or (iv) a coolant pressure drop between an inlet and an outlet for the coolant of the fuel cell stack, or (v) a coolant temperature rise between an inlet and an outlet for the coolant of the fuel cell stack.

20. The method according to claim 16, wherein the instruction includes a target operating mode for the technical system.

21. The method according to claim 13, wherein the determining of the determinant of the Hessian depends on a factorization including a strictly upper triangular part of a part of the Hessian, a strictly lower triangular part of the part of the Hessian, and a block diagonal matrix of recursively defined blocks of a matrix.

22. The method according to claim 13, wherein the determining of the inverse of the Hessian depends on a factorization includes a strictly upper triangular part of a part of the Hessian, a strictly lower triangular part of the part of the Hessian, and a block diagonal matrix of recursively defined blocks of a matrix.

23. The method according to claim 13, wherein the evaluating of the approximate lower bound includes sampling with samples of the second latent variable that are drawn from the approximate distribution over the second latent variable.

24. A device for machine learning with time-series data representing observations related to a technical system, the device comprising:
at least one processor; and
at least one memory;
wherein the at least one processor is adapted to execute instructions, the instructions, when executed by the at least one processor, cause the at least one processor to perform the following steps:
providing the time-series data, and model parameters of a distribution over the time-series data and over a first latent variable and over a second latent variable, and variational parameters of an approximate distribution over the second latent variable;
sampling a value of the second latent variable from the approximate distribution over the second latent variable;
finding a value of the first latent variable depending on a density of the distribution over the time-series data and over the first latent variable and over the value of the second latent variable, that maximizes the density of the distribution over the time-series data and over the first latent variable and over the value of the second latent variable;
determining a Hessian depending on a second order Taylor approximation of the distribution over the time-series data and the first latent variable and the value of the second latent variable evaluated at the value of the first latent variable;
determining a determinant of the Hessian;
determining a Laplace approximation of a distribution over the time-series data conditioned with the value of the second latent variable depending on the determinant of the Hessian;
determining an inverse of the Hessian;
determining a Jacobian of the distribution over the time-series data and the first latent variable and the value of the second latent variable;
evaluating an approximate lower bound that depends on the Laplace approximations that are determined for a plurality of values of the second latent variable; and
determining gradients of the Laplace approximations depending on the inverse Hessian and the Jacobian;
updating the model parameters and the variational parameters depending on the gradients;
determining an instruction for actuating the technical system depending on the time-series data, the model parameters, and the variational parameters; and
outputting the instruction to cause the technical system to act.

25. The device according to claim 24, wherein the device further comprises an interface that is adapted to receive information about the technical system and/or that is adapted to output the instruction that causes the technical system to act.

26. A non-transitory computer-readable medium on which is stored a computer program including computer readable instructions for machine learning with time-series data representing observations related to a technical system, the instructions, when executed by a computer, causing the computer to perform the following steps:
providing the time-series data, and model parameters of a distribution over the time-series data and over a first latent variable and over a second latent variable, and variational parameters of an approximate distribution over the second latent variable;
sampling a value of the second latent variable from the approximate distribution over the second latent variable;
finding a value of the first latent variable depending on a density of the distribution over the time-series data and over the first latent variable and over the value of the second latent variable, that maximizes the density of the distribution over the time-series data and over the first latent variable and over the value of the second latent variable;
determining a Hessian depending on a second order Taylor approximation of the distribution over the time-series data and the first latent variable and the value of the second latent variable evaluated at the value of the first latent variable;
determining a determinant of the Hessian;
determining a Laplace approximation of a distribution over the time-series data conditioned with the value of the second latent variable depending on the determinant of the Hessian;
determining an inverse of the Hessian;
determining a Jacobian of the distribution over the time-series data and the first latent variable and the value of the second latent variable;
evaluating an approximate lower bound that depends on the Laplace approximations that are determined for a plurality of values of the second latent variable; and
determining gradients of the Laplace approximations depending on the inverse Hessian and the Jacobian; and
updating the model parameters and the variational parameters depending on the gradients.
